(19) United States
(12) Patent Application Publication
(10) Pub. No.: US 2019/0350402 A1
(43) Pub. Date: Nov. 21, 2019

(54) SYSTEM AND METHOD FOR BREWING A CUP OF COFFEE

(71) Applicant: Mere Coffee, Inc., San Francisco, CA (US)

(72) Inventors: Scott Steber, San Francisco, CA (US); Greg Kress, San Francisco, CA (US)

(21) Appl. No.: 16/398,179

(22) Filed: Apr. 29, 2019

Related U.S. Application Data
(63) Continuation of application No. 15/923,215, filed on Mar. 16, 2018.
(60) Provisional application No. 62/678,179, filed on May 30, 2018.
(60) Provisional application No. 62/472,652, filed on Mar. 17, 2017.

(51) Int. Cl. A47J 31/42; A47J 31/44; A47J 31/52; A47J 31/54; A47J 31/46

(52) U.S. Cl. CPC A47J 31/42; A47J 31/4492; A47J 31/468; A47J 31/4403; A47J 31/542; A47J 31/52

(57) ABSTRACT

One variation of a method includes, at a system configured to brew a cup of coffee: reading an identifier from a packet; accessing a brew recipe based on the identifier; triggering a door actuator to open an inlet door on the system; initiating a brew cycle according to the brew recipe; during the brew cycle, activating a grinder for a grind duration to grind whole beans dispensed from the packet through the inlet door in response to manual closure of the inlet door, dispensing coffee grounds from the grinder into a brew chamber, heating a volume of water to a target temperature specified in the brew recipe, dispensing the volume of water into the brew chamber, and agitating the volume of water and coffee grounds in the brew chamber; and transferring fluid out of the brew chamber in response to conclusion of the brew cycle.

### CROSS-REFERENCE TO RELATED APPLICATIONS

This Application claims the benefit of U.S. Provisional Application No. 62/678,179, filed on 30 May 2018, which is incorporated in its entirety by this reference.

This Application is a continuation-in-part application of U.S. patent application Ser. No. 15/923,215, filed on 16 Mar. 2018, which claims the benefit of U.S. Provisional Application No. 62/472,652, filed on 17 Mar. 2017, each of which is incorporated in its entirety by this reference.

### TECHNICAL FIELD

This invention relates generally to the field of coffee and more specifically to a new and useful system and method for brewing a cup of coffee in the field of coffee.

### BRIEF DESCRIPTION OF THE FIGURES

FIG. 1 is a schematic representation of a system; and

FIG. 2 is a flowchart schematic of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

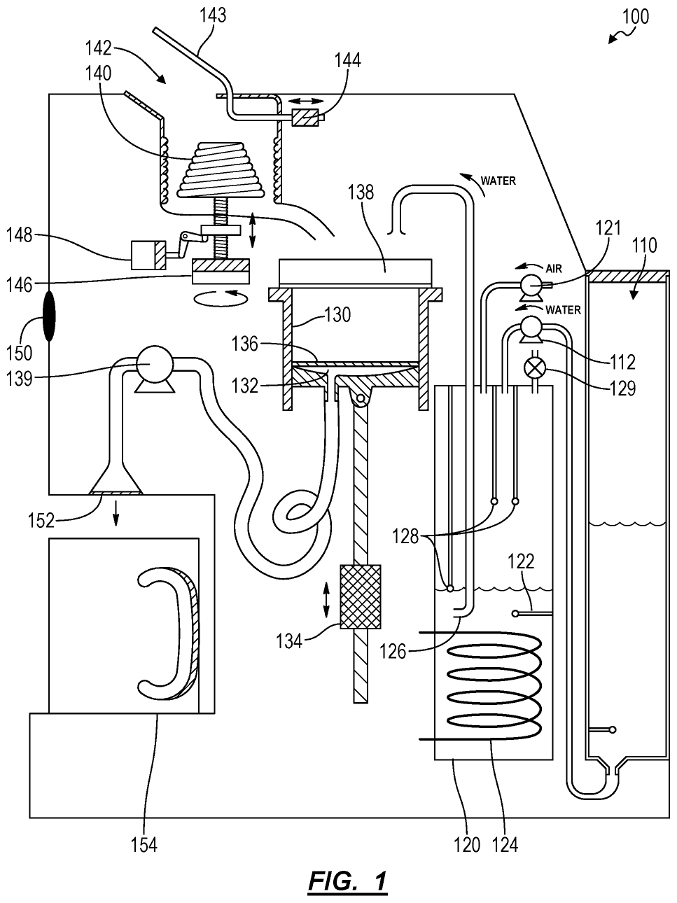

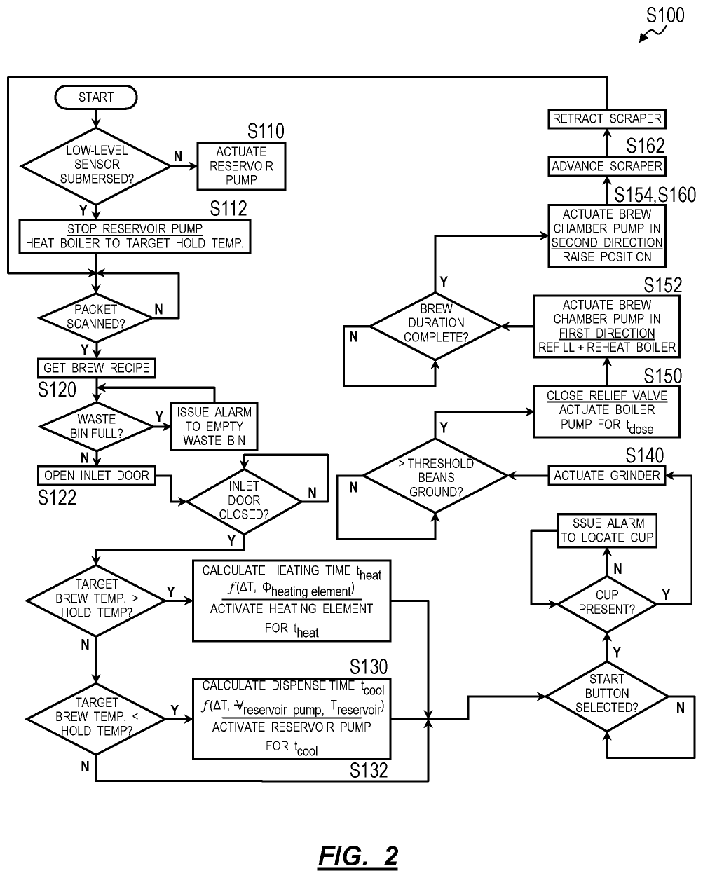

As shown in FIGS. 1 and 2, a method S100 for brewing a cup of coffee includes: activating a reservoir pump 112 to dispense cool water from a reservoir 110 into a boiler 120 to fill the boiler 120 with a target hold volume of water in Block Silo; heating contents of the boiler 120 to a target hold temperature within a range of possible target brew temperatures in Block S112; in response to scanning an identifier from a single-serving packet of whole coffee beans, retrieving a brew recipe for the single-serving packet based on the identifier in Block S120 and triggering an inlet door 143 to open in Block S122; in response to the brew recipe specifying a target brew temperature less than the target hold temperature, calculating a target volume of cool water to pump from the reservoir 110 into the boiler 120 to drop an average temperature of water in the boiler 120 to the target brew temperature in Block S130 based on a temperature of water in the reservoir 110, the target hold volume, the target hold temperature, and the target brew temperature; in response to the inlet door 143 closing, activating the reservoir pump 112 to dispense the target volume of cool water from the reservoir 110 into the boiler 120 in Block S132 and activating a grinder 140 actuator to grind a volume of whole coffee beans—previously loaded into a grinder 140 via the inlet door 143—into grounds dispensed by the grinder 140 into a brew chamber 130 in Block S140; in response to the grinder 140 grinding a threshold portion of the volume of whole coffee beans into coffee grounds, activating a boiler pump 121 to displace a volume of heated water, approximately at the target brew temperature, from the boiler 120 into the brew chamber 130 in Block S150; actuating a brew chamber 130 pump in a first direction to pump air through a piston 132 in the brew chamber 130 to agitate coffee grounds and the volume of heated water in the brew chamber 130 in Block S152; in response to conclusion of a brew duration specified by the brew recipe, actuating the brew chamber 130 pump in a second direction in order to pump liquid out of the brew chamber 130 through a filter 136 arranged across a face of the piston 132, through the piston 132, and through a brew dispense port 152 arranged over a cup stand 154 and in order to remove moisture from coffee grounds located in the brew chamber 130 in Block S154; triggering a piston actuator 134 to raise the piston 132 to a position flush with a top of the brew chamber 130 in Block S160; and triggering a scraper 138 actuator to drive a scraper 138 forward over the top of the brew chamber 130, over the face of the piston 132, and toward a compost (or “waste”) bin to discard coffee grounds from the brew chamber 130 into the waste bin in Block S162.

### 2. Applications

As shown in FIG. 1, the method S100 can be executed by a system 100 defining an automated coffee machine to: automatically retrieve a brew recipe for a single-serving of whole coffee beans; to automatically grind these coffee beans according to the brew recipe; to heat water to a target brew temperature specified by the brew recipe; to dispense water and coffee grounds into a brew chamber 130; to agitate contents of the brew chamber 130 according to the brew recipe; to actively pump liquid (i.e., coffee) out of the brew chamber 130 and into a coffee cup following a brew duration specified by the brew recipe; and to automatically clean used coffee grounds out of the brew chamber 130 in preparation for brewing a next single serving of coffee.

Generally, Blocks of the method S100 can be executed by the system 100 in order to rapidly and precisely brew a cup of coffee from a volume of whole coffee beans based on various brew parameters specified in a brew recipe for these whole coffee beans. More specifically, the system 100 can implement Blocks of the method S100 in order to hold water in the boiler 120 at a target hold temperature that enables the system 100 to rapidly adjust the temperature of this volume of water to any target brew temperature—within a range of possible brew temperatures—specified by a current brew recipe by either briefly reactivating a heating element 124 in the boiler 120 or dosing the boiler 120 with cool water stored in the reservoir 110. The system 100 can also overlap certain operations within a brew cycle—such as grinding beans into the brew chamber 130, dispensing heated water from the boiler 120 into the brew chamber 130, and refilling the boiler 120—in order to both shorten the current brew cycle and to prepare the system 100 to quickly execute a next brew cycle, thereby limiting a perceived duration of a brew cycle for a user.

### 3. Water Reservoir

The system 100 can include a reservoir 110 defining a container configured to store a volume of cool water, such as standing water at or near room temperature. The reservoir 110 can also include a temperature sensor 122 arranged near a base of the reservoir 110 and configured to output a signal corresponding to a temperature of water in the reservoir 110.

(In one variation, rather than a reservoir 110 and a reservoir pump 112, the fluid system instead includes: a supply tap configured to receive fluid from a pressurized water supply in a building (e.g., at a kitchen counter); and a pressure regulator, a flow regulator, and an actuatable valve interposed between the supply tap and reservoir 110. During a brew cycle, the system 100 can implement methods and techniques described below to selectively trigger the valve to open in order to release cool water from the pressurized water supply into the boiler 120, such as to refill the boiler 120 or to reduce the average temperature of water in the boiler 120 during a brew cycle. In this variation, the system 100 can also include a temperature sensor 122 fluidly coupled to the water supply, such as arranged inside or adjacent the valve.)

### 4. Boiler

The system 100 also includes a boiler 120 configured to store a volume of water, configured to heat this volume of water to a target temperature, and configured to function as a mixing chamber in which water heated in the boiler 120 is mixed with cool water from the reservoir 110 to quickly drop the average temperature of water in the boiler 120 prior to dispensing into the brew chamber 130.

In one implementation, the boiler 120 includes: a vessel; and a set of water level probes 128 arranged at different heights within the vessel and configured to output signals indicating presence of absence of adjacent fluid. For example, the boiler 120 can include: a low-level probe 128 set at a height corresponding to a target hold water volume in the boiler 120, such as 700 mL; a high-level probe 128 set at a height corresponding to a maximum water volume in the boiler 120, such as 900 mL; and a probe energizer extending below the low-level probe 128. To sample the water level probes 128, the system 100 can hold the probe energizer at a voltage HI. In this example, the low- and high-level probes 128 can output voltage-LO signals when the water level in the boiler 120 is less than the target hold water volume. When the water level in the boiler 120 is between the target hold water volume and the maximum water volume, the low-level probe 128 can output a voltage-HI signal and the high-level probe 128 can continue to output a voltage-LO signal. Once the water level in the boiler 120 reaches the maximum water volume, the low- and high-level probes 128 can both output voltage-HI signals. The system 100 can therefore determine whether the current amount of water in the boiler 120 is less than the target hold water volume, is between the target hold water volume and the maximum water volume, or has reached the maximum water volume based on states and state changes of the low- and high-level probes 128 in the boiler 120. The boiler 120 can further include a calibration level probe 128(s) set at a height between the low-level and the high-level probes 128.

The boiler 120 can also include a boiler 120 inlet 142 arranged proximal the top of the vessel such that a volume of cool water injected into the boiler 120—from the reservoir 110—via the boiler 120 inlet 142 “splashes” down into the volume of heated water currently occupying the boiler 120 via the boiler 120 inlet 142, thereby inducing turbulence in the boiler 120, promoting mixing between the volume of heated water stored in the boiler 120 and the volume of cool water injected into the boiler 120, and limiting a temperature gradient within the boiler 120 soon after this cool water is injected. For example, the boiler 120 inlet 142 can include a nozzle facing directly downward toward the bottom of the vessel. The boiler 120 can further include a pressure port and a relief port proximal the top of the vessel.

Furthermore, the boiler 120 can include a heating element 124. For example, the heating element 124 can include a coil-shaped immersion heater arranged proximal the base of the vessel and below the low-level probe 128. The boiler 120 can also include an outlet sump 126 arranged between the low-level probe 128 and the top of the heating element 124 such that the output port is immersed in water when the target hold volume of water is present in the boiler 120. To pump heated water out of the boiler 120, the system 100 can pump air into the top of the boiler 120 and thus force water below into the outlet sump 126 and out of the boiler 120, as described below. However, once the water level in the boiler 120 drops below the outlet sump 126, the outlet sump 126 may no longer pick up water, and air pumped into the boiler 120 may exit directly out of the boiler 120 via the outlet sump 126, thereby preventing dispensation of water out of the boiler 120 to a level below the top of the heating element 124 and thus ensuring that the heating element 124 remains fully-immersed in water at all times, even if various pumps or sensors within the system 100 malfunction.

The boiler 120 can further include a temperature sensor 122, such as centered in the boiler 120 between the low-level probe 128 and the top of the heating element 124 and configured to output a signal corresponding to a temperature of an adjacent volume of water inside the boiler 120. The boiler 120 can also include multiple temperature sensors 122, such as one temperature sensor 122 centered at the base of the boiler 120, a second temperature sensor 122 arranged on the wall of the boiler 120, and a third temperature sensor 122 centered in the boiler 120 between the low-level probe 128 and the top of the heating element 124. The system 100 can thus sample the temperature sensor 122(s) in order to monitor the temperature of water within the boiler 120 over time.

### 4.1 Valves and Pumps

In one implementation, the system 100 also includes: a reservoir pump 112 (e.g., a positive-displacement pump, such as centrifugal or peristaltic pump) configured to pump water from the reservoir 100 and the boiler 120 inlet 142 on the boiler 120; a check valve arranged between the reservoir pump 112 and the boiler 120 inlet 142 and configured to prevent air and water from back-flowing from the boiler 120 toward the reservoir 100; and a relief valve 129 (e.g., a solenoid-controlled relief valve 129) fluidly coupled to the relief port proximal the top of the boiler 120 and controllable by the system 100 to selectively open the boiler 120 to atmospheric pressure. Generally, when either the reservoir pump 112 is active or when the heating element 124 in the boiler 120 is active, the system 100 can trigger the relief valve 129 to open in order to maintain the inside of the boiler 120 at ambient pressure and thus prevent unintended displacement of water out of the boiler 120. (Alternatively, the relief valve 129 can default to an open state, and the system 100 can release the relief valve 129 when either the reservoir pump 112 is active or when the heating element 124 in the boiler 120 is active.)

The system 100 also includes a boiler pump 121: fluidly coupled to the pressure port proximal the top of the boiler 120; and configured to pump air into the boiler 120 in order to displace heated water out of the boiler 120 via the outlet sump 126 in the boiler 120. In particular, to pump heated water out of the boiler 120, the system 100 can: trigger the relief valve 129 to close; and then activate the boiler pump 121, which pumps air into the top of the boiler 120 to increase pressure inside the boiler 120, which can then force heated water through the outlet sump 126 and toward the brew chamber 130.

(In one variation, the system 100 also includes a diversion valve (e.g., an assembly of two solenoid valves coupled to a “Y” fitting) coupled to the outlet sump 126 and configured to selectively divert water thus displaced through the outlet sump 126 to either of the brew chamber 130 or to a water dispense port 152 adjacent the brew dispense port 152 described below. For example, the system 100 can thus set the diversion valve to a first position to dispense water into the brew chamber 130 to brew coffee when a packet of coffee beans is scanned at the scanner. However, when a packet of tea or hot chocolate is scanned at the scanner, the system 100 can set the diversion valve to a second position to dispense water directly out of the water dispense port 152 and into a cup below once the system 100 has implemented methods and techniques described herein to drive water in the boiler 120 to a temperature specified in a recipe associated within the packet of tea or hot chocolate. Similarly, when a packet of coffee beans—associated with a brew recipe specifying total brew volume greater than a maximum brew volume of the brew chamber 130—is scanned at the scanner, the system 100 can: first set the diversion valve to the first position to dispense a first subvolume of the total brew volume into the brew chamber 130; implement methods and techniques described herein to refill the boiler 120 and drive water in the boiler 120 to a target temperature specified in the brew recipe; and then set the diversion valve to the second position to displace the remainder of the total brew volume through the water dispense port 152 and into a cup or pitcher below where this additional water heated mixes with brewed coffee also dispensed from the brew dispense port 152 around this time.)

Furthermore, once the boiler pump 121 has been active for a target duration of time corresponding to a target water volume for a current brew cycle, the system 100 can disable the boiler pump 121 and trigger the relief valve 129 to open, which may release pressure inside the boiler 120 and permit water currently occupying a fluid line between the boiler 120 and the brew chamber 130 to flow back into the boiler 120. After displacing heated water from the boiler 120 into the brew chamber 130, the system 100 can also refill the boiler 120 by activating the reservoir pump 112—while the relief valve 129 is open—to displace fluid from the reservoir 110 into the boiler 120 until the low-level probe 128 indicates that the water level inside the boiler 120 has reached the target hold volume represented by the position of the low-level probe 128 in the boiler 120. The system 100 can also activate the heating element 124 concurrently or soon thereafter in order to drive water in the boiler 120 back up to the target hold temperature.

### 4.2 Target Hold Temperature and Water Temperature Adjustment

The system 100 can maintain a target hold volume of water in the boiler 120 and implement dosed-loop controls to maintain this volume of water at target hold temperature (e.g., 94° C.) while the system 100 is on and at rest (i.e., not executing a brew cycle). In particular, the system 100 can load the boiler 120 with the target hold volume of water that is less than the total volumetric capacity of the boiler 120 to enable the system 100 to dose the boiler 120 with cooler water from the reservoir 110, thereby rapidly cooling heated water in the boiler 120 down to a target brew temperature specified in a brew recipe for a coffee bean (or other hot beverage) selected for the current brew cycle.

Furthermore, to minimize the amount of time needed to drive the target hold volume of water in the boiler 120 from a target hold temperature to a particular target brew temperature within a range of possible brew temperatures (e.g., from 88° C. to 86° C.), the system 100 can implement a target hold temperature within this range of possible brew temperatures. When the target brew temperature specified for a current brew cycle is less than the target hold temperature, the system 100 can dose the boiler 120 with cool water from the reservoir 110; however, when the target brew temperature specified for a current brew cycle is greater than the target hold temperature, the system 100 can activate the heating element 124 in the boiler 120 to increase the temperature of water in the boiler 120 to the higher target brew temperature. For example, the target hold temperature can be matched to the target hold volume, the typical (or maximum) thermal output of the heating element 124, and the flow rate of the reservoir pump 112 such that: a first duration of time needed to drop an average temperature of water in the boiler 120 to the low end of the range of possible brew temperatures by dispensing a volume of cool water at a typical room temperature (e.g., up to 74° C.) from the reservoir 110 into the boiler 120; matches a second duration of time needed to increase an average temperature of water in the boiler 120 to the high end of the range of possible brew temperatures by activating the heating element 124 in the boiler 120. For example, for a range of possible brew temperatures extending from 80° C. to 96° C. and a target hold volume of 700 mL, the system 100 can implement a target hold temperature of 94° C., which may enable the system 100 to cool water in the boiler 120 from 94° C. to 80° C. within seven seconds and to heat water in the boiler 120 from 94° C. to 96° C. within seven seconds.

For example, the boiler 120 can maintain the target hold volume of water at a target hold temperature of 94° C. When a next brew cycle specifying a lower target brew temperature of 93° C. is loaded into the system 100 and a next brew cycle is triggered, the system 100 can: read a temperature of water in the reservoir 110 (e.g., approximately 22° C. for room-temperature water); calculate a target volume of cool water at the reservoir 110 temperature to dispense from the reservoir 110 into the brew chamber 130 to drop the volume of heated water in the boiler 120 to this target brew temperature of 93° C.; transform this target volume of cool water into a target pump activation time (e.g., relatively short duration of one second) based on a known flow rate of the reservoir pump 112; and then activate the reservoir pump 112 for this target pump time in order to dispense this target volume of cool water into the boiler 120 and thus rapidly drop the average temperature of water in the boiler 120 down to the target brew temperature of 93° C.

Since cool water injected into heated water in the boiler 120 may induce local temperature gradients within the boiler 120 as the cool and heated water mix, temperature readings output by a temperature sensor 122 in the boiler 120 may be inconsistent. The system 100 can therefore estimate the average temperature of water in the boiler 120 after injecting this volume of cool water based on: a temperature reading and a known volume of heated water in the boiler 120 prior to injecting this volume of cool water; an estimated volume of cool water injected into the boiler 120 (e.g., based on a duration that the reservoir pump 112 is active and known flow rate of the reservoir pump 112); and a temperature of the cool water in the reservoir 110. The system 100 can then predict that the average temperature of water in the boiler 120 will remain substantially unchanged from the time the volume of cool water was injected to a time that a target volume of water is dispensed into the brew some time (e.g., up to four seconds) later.

Then, once a threshold proportion of beans dispensed into the system 100 for this brew cycle have been ground and dispensed into the brew chamber 130—such as within seconds of the system 100 dropping the average temperature of water in the boiler 120 down to 93° C.—the system 100 can pump water from the boiler 120 into the brew chamber 130. Once a target volume of water for this brew cycle is dispensed into the brew chamber 130, the system 100 can immediately refill the boiler 120 with cool water from the reservoir 110 up to the target hold volume of water and activate the heating element 124 in the boiler 120 to heat this volume of water back up to the target hold temperature of 94° C.

Later, when another brew cycle specifying an even lower target brew temperature of 88° C. is loaded into the system 100 and a next brew cycle is triggered, the system 100 can similarly: read a temperature of water in the reservoir 110; calculate a target volume of cool water at the reservoir 110 temperature to dispense from the reservoir 110 into the brew chamber 130 to drop the volume of heated water in the boiler 120 to this target brew temperature of 88° C.; transform this target volume of cool water into a target pump activation time (e.g., relatively long duration of six seconds) based on the known flow rate of the reservoir pump 112; and then activate the reservoir pump 112 for this target pump time in order to dispense this target volume of cool water into the boiler 120 and thus rapidly drop the average temperature of water in the boiler 120 down to the target brew temperature of 88° C. Once a threshold proportion of beans dispensed into the system 100 for this brew cycle have been ground and dispensed into the brew chamber 130—such as within seconds of the system 100 dropping the average temperature of water in the boiler 120 down to 88° C.—the system 100 can pump water from the boiler 120 into the brew chamber 130. Once a target volume of water for this brew cycle is dispensed into the brew chamber 130, the system 100 can immediately refill the boiler 120 with cool water from the reservoir 1100 up to the target hold volume of water and activate the heating element 124 in the boiler 120 to heat this volume of water back up to the target hold temperature of 94° C.

Furthermore, when a next brew cycle specifying an higher target brew temperature of 96° C. is loaded into the system 100 and a next brew cycle is triggered, the system 100 can immediately activate the heating element 124 to heat the target hold volume of water currently occupying the boiler 120 and monitor the temperature of this volume of water through a temperature sensor 122 in the boiler 120. Once a threshold proportion of beans dispensed into the system 100 for this brew cycle have been ground and dispensed into the brew chamber 130—such as within seconds of the system 100 increasing the average temperature of water in the boiler 120 up to 96° C.—the system 100 can pump water from the boiler 120 into the brew chamber 130. Once a target volume of water for this brew cycle is dispensed into the brew chamber 130, the system 100 can immediately refill the boiler 120 with cool water from the reservoir 110 up to the target hold volume of water and activate the heating element 124 in the boiler 120 to heat this volume of water back up to the target hold temperature of 94° C.

The system 100 can therefore maintain a target hold volume of water—in the boiler 120—at a target temperature between a minimum brew temperature (e.g., 88° C.) and a maximum brew temperature (e.g., 96° C.) specified by brew recipes of various coffees (and other hot beverages, such as tea and hot chocolate)—and biased toward the maximum brew temperature—in order to enable the system 100: to rapidly drop the temperature of water in the boiler 120 to a lower target brew temperature by quickly dosing the brew chamber 130 with cooler water from the reservoir 110; and to rapidly increase the temperature of water in the boiler 120 to a higher target brew temperature by briefly activating the heating element 124 in the boiler 120; and to thus minimize a time from confirmation of a next brew cycle by a user to dispensation of a metered volume of water at the specified brew temperature for this brew cycle—with a tight tolerance (e.g., +/−0.2° C.)—into the brew chamber 130.

### 4.3 Flow Rate Calibration Cycle

In one variation, the system 100 automatically executes a flow rate calibration cycle to derive a flow rate of water from the reservoir 110 into the boiler 120 when the reservoir pump 112 is active and to derive a flow rate of water from the boiler 120 into the brew chamber 130 when the boiler pump 121 is active. For example, the system 100 can automatically execute a flow rate calibration routine: when the system 100 is turned “ON”; after each service event (i.e., when the system 100 is serviced by a technician, such as semi-weekly); after the system 100 completes a preset number of brew cycles (e.g., 200 brew cycles); or at the beginning or end of each day in order to compensate for wear in components within the system 100, changes in local barometric pressure, etc.

In one implementation, during a flow rate calibration routine, the system 100 closes the relief valve 129 and activates the boiler pump 121 to displace water from the boiler 120 and into the brew chamber 130 until the low-level probe 128 changes state to indicate that the water level has dropped below the low-level probe 128. The system 100 then opens the relief valve 129; initiates a timer; and activates the reservoir pump 112 to pump water from the reservoir 110 into the boiler 120. Once the calibration probe in the boiler 120 changes state to indicate that the water level has risen to the height of the calibration probe in the boiler 120, the system 100 can disable the reservoir pump 112 and store a current time on the timer as a duration of time over which the reservoir pump 112 is capable of pumping a volume of water—equal to a known volume difference between the low-level probe 128 and the calibration probe (e.g., 100 mL)—from the reservoir 110 into the boiler 120. The system 100 can then divide this known volume difference by this duration of time and store this value as a volume flow rate of the reservoir pump 112.

(Additionally or alternatively, the system 100 can activate the reservoir pump 112 until the high-level probe 128 changes state to indicate that the water level in the boiler 120 has risen to the high-level probe 128; the system 100 can then disable the reservoir pump 112, store a current time on the timer as a duration of time over which the reservoir pump 112 can pump a volume of water—corresponding to a volume difference between the low- and high-level probes 128 (e.g., 200 mL)—from the reservoir 110 into the boiler 120, and then calculate volume flow rate of the reservoir pump 112 based on this duration and known volume difference between the low- and high-level probes 128.)

The system 100 can then: close the relief valve 129; activate a timer; and activate the boiler pump 121 to displace water from the boiler 120 and into the brew chamber 130. Once the low-level probe 128 changes state to indicate that the water level has dropped below the low-level probe 128, the system 100 can disable the boiler pump 121 and store a current time on the timer as a duration of time over which the boiler pump 121 can pump a volume of water—corresponding to the known volume difference between the calibration probe and the low-level probe 128 (e.g., 100 mL)—from the boiler 120 into the brew chamber 130. The system 100 can then divide this known volume difference by this duration of time and store this value as a volume flow rate of the boiler pump 121.

The system 100 can then implement these volume flow rates of the reservoir pump 112 and the boiler pump 121 when calculating durations of times to activate the reservoir and boiler pumps during subsequent brew cycles, as described above and below.

### 5. Brew Chamber

The system 100 also includes a brew chamber 130 into which the grinder 140 dispenses coffee grounds and into which the boiler pump 121 displaces heated water from the boiler 120 in order to brew a serving of coffee. In one implementation, the brew chamber 130 includes: a cylinder arranged vertically, offset vertically above the boiler 120, and defining an open top; a piston 132 running vertically inside the cylinder; and a piston actuator 134 configured to raise and lower the piston 132 inside the cylinder. In this implementation, the piston 132 can include: a piston 132 base configured to mate with the interior wall of the cylinder; a seal configured to seal against the interior wall of the cylinder; a relief (e.g., a “valley”) across the top face of the piston 132 base; a piston 132 port running vertically through the piston 132 base and intersecting the relief; and a filter 136 defining an array of fine perforations (e.g., in the form of a “portafilter”) and fastened to the piston 132 base over the relief. For example, the filter 136 can include a stainless steel disc defining the array of perforations that yields a 40% open area across the face of the disc, and wherein each perforation in this area defines a bore approximately 0.004″ wide by 0.004″ long.

### 6. Cup Stand

The system 100 can also include: a brew dispense port 152 arranged proximal the front of the system 100, such as under the start button 150 and under the inlet door 143; a cup stand 154 arranged under the brew dispense port 152 and configured to support a cup under the brew dispense port 152; and a drip tray arranged under (or physically coextensive with) the cup stand 154 and configured to collect spilled liquid and liquid that may drip from the brew dispense port 152 after a cup is removed from the cup stand 154. The system 100 can further include a cup sensor configured to output a signal corresponding to presence of a cup on the cup stand 154. For example, the cup sensor can include an infrared distance sensor or a capacitive proximity sensor.

### 7. Brew Chamber Pump

The system 100 can also include: a brew chamber 130 pump fluidly coupled on one end to the piston 132 port on the piston 132 and fluidly coupled on the opposite end to the brew dispense port 152; and a flexible fluid line fluidly coupled to the piston 132 port and to the brew chamber 130 pump and configured to deform in order to accommodate changes in the vertical position of the piston 132 relative to the brew chamber 130 pump as the piston actuator 134 moves the piston 132 vertically within the brew chamber 130. Generally, the brew chamber 130 pump is configured: to pump air into the brew chamber 130—via the filter 136 across the face of the piston 132—in order to agitate fluid contents in the brew chamber 130 during a brew cycle; and to actively pump fluid (e.g., hot coffee) out of the brew chamber 130 at the conclusion of a brew cycle—thereby rapidly terminating the brew cycle—and into a cup arranged below the brew dispense port 152.

In particular, the brew chamber 130 pump can be operable in a first direction—once the boiler pump 121 has pumped heated water from the boiler 120 into the brew chamber 130—to pump ambient air from the brew dispense port 152 into the piston 132 port, and through the filter 136 on the piston 132 to bubble air into the brew chamber 130, thereby agitating heated water and coffee grounds occupying the brew chamber 130 and increasing a rate and completeness of flavor extraction from these coffee grounds into the heated water. The brew chamber 130 pump can also be operable in a second direction—at the conclusion of a brew cycle—to actively draw fluid contained in the brew chamber 130 through the filter 136, into the relief in the piston 132 base, down through the piston 132 port, through a flexible fluid line, out of the brew dispense port 152, and thus into a cup occupying the cup stand 154. For example, the brew chamber 130 pump can include a peristaltic pump: operable in both the first and second directions; and configured to hold pressure in the flexible fluid between the brew chamber 130 pump and the piston 132 when not active in order to prevent fluid in the brew chamber 130 from flowing down through the filter 136 and out of the brew chamber 130 during a brew cycle.

However, the brew chamber 130 pump can include one or more pumps of any other type.

### 8. Splash Guard

In one variation, the system 100 also includes a splashguard coupled to the brew dispense port 152 and configured to reduce an exit velocity of liquid from the brew dispense port 152 and thus reduce opportunity for liquid dispensed through the brew dispense port 152 to splash out of a cup placed on the cup stand 154 below.

For example, the splashguard can include a wire mesh arranged across the outlet of brew dispense port 152. When coffee is pumped out of the brew chamber 130 and through the brew dispense port 152, the wire mesh can interrupt flow of this coffee through the brew dispense port 152 and cause this coffee to mix with air as the coffee moves through the disperse port, thereby both: reducing a speed of coffee through the brew dispense port 152 to reduce opportunity for coffee to splash out of the cup below; and increasing a rate of oxidization of the coffee, which may decompose or neutralize tannins in the coffee and thus reduce bitterness and improve flavor of this coffee. In another example, the splashguard includes a series of baffle plates arranged across the outlet of the brew dispense port 152.

In a similar example, the splashguard can include: a top jet plate; an air channeling body; and a set of wire mesh screens. The top jet plate can include a ring of small orifices (e.g., one-millimeter-wide Venturies). As liquid (e.g., coffee) flows through these orifices in the top jet plate, the velocity of this fluid may increase, which may decrease pressure across these orifices, which may thus draw air into a set of air channels around the perimeter of the air channeling body. Air and liquid moving through the splashguard can crash into the set of wire mesh screens defining convoluted flow path) and thus mix before dropping into a cup below as an “aerated liquid stream.” By thus aerating the liquid passing, the splashguard can decrease likelihood of large, impactful jets or droplets forming at the exit of the brew dispense port 152 such that this aerated liquid stream falls more gently into a cup below, thereby decreasing splashing (and masking pulsations of the brew chamber 130 pump). Furthermore, by thus aerating the liquid, the splashguard may slightly foam the liquid, thereby improving a perceived smoothness and flavor of the liquid for a user.

Alternatively, the system 100 can include a cluster of brew dispense ports 152 (e.g., a tight group of ten discrete brew dispense ports 152) fluidly coupled to the brew chamber 130 pump. These brew dispense ports 152 can thus cooperate to limit a maximum volume flow rate through any one brew dispense port 152 and thus reduce opportunity for liquid dispensed from the system 100 to splash out of a cup below.

### 9. Grinder

The system 100 also includes: a whole bean inlet 142; an inlet door 143 arranged over the whole bean inlet 142; a door actuator 144 (e.g., a solenoid) configured to open to the inlet door 143; a door position sensor configured to output a signal corresponding to a state of the inlet door 143; a grinder 140 fluidly coupled to the whole bean inlet 142; a hopper interposed between the whole bean inlet 142 and the grinder 140 and configured to hold a serving of whole coffee beans before the grinding is actuated at the start of a brew cycle; a primary grinder actuator 146 configured to actuate the grinder 140 to grind whole coffee beans dispensed into the whole bean inlet 142; and a ground chute fluidly coupled to the brew chamber 130 and configured to dispense coffee grounds—output by the grinder 140—into the brew chamber 130.

Generally, the grinder 140 is configured to receive whole coffee beans dispensed into the whole bean inlet 142, to grind these coffee beans into coffee grounds, and to dispense these grounds into the ground duct, which then funnels these grounds into the brew chamber 130. In one implementation shown in FIG. 1, the grinder 140 includes: a burr grinder 140 defining an inlet 142 and an outlet; and a primary grinder actuator 146 configured to rotate the burr grinder 140, thereby grinding whole coffee beans at the inlet 142 into coffee grounds upon passing through the outlet. The burr grinder 140 can also be adjustable. For example, the grinder 140 can further include: a grinder adjustment actuator 148 configured to adjust relative positions of elements of the burr grinder 140 according to a ground size parameter specified in a brew recipe for a current brew cycle; and a burr position sensor (e.g., an optical encoder or potentiometer) coupled to the grinder adjustment actuator 148 or mounted directly to the elements of the burr grinder 140. In this example, before activating the primary grinder actuator 146 at the start of a next brew cycle, the system 100 can: extract a ground size (e.g., between fine and coarse) from a brew recipe for this brew cycle; retrieve a target position of elements of the burr grinder 140 from a lookup table—stored in local memory—based on this ground size; and then implement closed-loop controls to move the grinder adjustment actuator 148 until the burr position sensor indicates that this target position has been reached. The system 100 can thus interface with the grinder adjustment actuator 148 and the burr position sensor to adjust the elements in the grinder 140 such that grounds—ground from whole beans by the grinder 140—exhibit an average ground size (e.g., maximum or average width) approximating a target ground size specified in the brew recipe for the current brew cycle.

In another implementation, the system 100 sets the grinder 140 to an intermediate ground size position at the conclusion of a preceding grind cycle. At the beginning of a next brew cycle, the system 100 extracts a target ground size from a brew recipe for this brew cycle; once whole beans are loaded into the whole bean inlet 142 and the whole bean inlet 142 is closed (and once a start button 150 on the system 100—such as adjacent the whole bean inlet 142—is manually selected), the system 100 can activate the primary grinder actuator 146 to begin grinding whole beans at the intermediate ground size. With the grinder 140 now active, the system 100 can activate the grinder adjustment actuator 148 to (rapidly) adjust the burr grinder 140 to a ground size position specified by the brew recipe, such as within three seconds of activating the primary grinder actuator 146. The grinder 140 can continue to grind the whole beans—now to the specified ground size—for a preset ground duration (e.g., an additional four seconds). (Toward the conclusion of the grind cycle, the system 100 can also reactivate the grinder adjustment actuator 148 to adjust the burr grinder 140 back to the intermediate ground size position in preparation for a next brew cycle and then cease operation of the grinder 140.) Therefore, the system 100 can selectively adjust the burr grinder 140 only when the grinder 140 is active, thereby reducing opportunity for the burr grinder 140 to jam and limiting total duration of a brew cycle. The system 100 can repeat this process for each subsequent brew cycle.

### 10. Waste Management

The system 100 can also include: a compost bin offset laterally from and arranged below the top of the brew chamber 130; a scraper 138 actuator; and a scraper 138 configured to run over the top of the brew chamber 130 and toward the compost bin in order to drive coffee grounds from over the top of the piston 132—set flush with the top of the brew chamber 130 by the piston actuator 134, as described below—into the compost bin. For example, the scraper 138 actuator can be configured: to advance the scraper 138 from a first side of the brew chamber 130, over and past the piston 132, up to (or into) the compost bin on the second side of the brew chamber 130, and over a tab that jostles the scraper 138 in order to deposit used coffee grounds into the compost bin; and to retract the scraper 138 back to the first side of the brew chamber 130. Furthermore, the scraper 138 can include: a rigid (e.g., stainless steel) platen; and an elastic (e.g., silicone) gasket extending across a bottom leading edge of the platen, configured to run across the top of the brew chamber 130 and across the face of the piston 132, and thus configured to scrape used coffee grounds off of these surfaces and into the compost bin.

In this implementation, the system 100 can also include a waste sensor configured to output a signal corresponding to an amount of waste in the compost bin. For example, the system 100 can include an infrared depth sensor arranged over and facing downward toward the compost bin; and the system 100 can sample a value from this depth sensor and estimate a total amount of waste (i.e., used coffee grounds) in the compost bin based on this value.

### 11. User Interface

The system 100 also includes a scanner configured to read an identifier (or “ID”) from a packet containing whole coffee beans. For example, a serving of whole coffee beans (e.g., a quantity or weight of whole coffee beans sufficient to brew one cup of coffee) can be stored and sealed inside a packet including a compostable paper pouch. (Alternatively, the packet can include a box, carton, tube, can, cup, or other container.) Textual information about coffee beans contained inside the packet (e.g., name, origin, roaster, roast date, prominent flavors and aromas, etc.) and a one-dimensional barcode containing identifying information of these coffee beans can be printed directly onto the packet or printed onto compostable stickers that are then applied to the packet. In this example, the scanner can include a one-dimensional optical barcode scanner; when the packet is held in view of the scanner, the scanner can extract identifying information from the barcode, such as in the form of an alphanumeric code. Upon receipt of this code, the system 100 can extract a brew recipe directly from the code, such as including: ground size; water temperature; water volume; steep duration; and an agitation profile specified by the roaster. Alternatively, the system 100 can pass the code through a name mapping system—such as at a remote server via an Internet or cellular connection or stored in a local cache of recipes—to access the brew recipe.

In other implementations, the packet includes a quick-response code or an RFID tag containing identifying information and/or a brew recipe for beans contained in the packet; and the scanner can include a two-dimensional barcode scanner or an RFID reader configured to wirelessly access these identifying information and/or brew recipe data from the packet. However, the scanner can be of any other type and can be configured to retrieve identifying information and/or brew recipe data from a packet—containing a single serving of whole coffee beans or a serving of tea, cocoa powder, etc.—in any other way, such as through optical character recognition of an alphanumeric label applied to the packet, a color detection of a color code applied to the packet, etc.

Generally, the system 100 can interface with single-serving packets containing a quantity of whole coffee beans sufficient to brew a single cup of coffee. For example, the single serving packet can include: a compostable, sealed wax paper (or biopolymer-lined paper) pouch containing approximately twenty grams of coffee beans; and a barcode (or quick response code or other identifier) printed on the exterior of the pouch. In this example, the pouch can include a perforated or folded region to indicate a tear line and assist tearing across a mouth of the pouch. Alternatively, the pouch can include notches on each side of its mouth to assist tearing of the pouch across its mouth. Furthermore, in this example, the barcode (or other identifier) can be arranged across this tear line such that the barcode is destroyed when the pouch is torn open, thereby preventing future reuse of the pouch to initiate a brew cycle with coffee beans not sourced from the pouch itself. In one variation, the system 100 further includes a packet dispenser from which a user may retrieve a packet and which directly transmits a packet identifier to the system 100.

Alternatively, the barcode (or other identifier) can include a (substantially) unique identifier that uniquely identifies the individual packet; when the system 100 scans the packet, as described above, the system 100 can thus: check this unique identifier against a local database of unique identifiers previously read from other packets at the system 100; and/or check this unique identifier against a global database—stored remotely from the system 100—of unique identifiers previously read from other packets across many other instances of the system 100 to confirm that the packet is new and previously unused. If the system 100 thus confirms that the packet is new and previously unused, the system 100 can retrieve a brew recipe for the coffee beans contained in this packet, trigger the whole bean inlet 142 to open, and execute a brew cycle to brew a single cup of coffee from these whole coffee beans, as described below.

However, the system 100 can identify whole or pre-ground beans—stored in packaging of any other type or format—in any other way.

The system 100 can also include a start button 150, such as arranged proximal the scanner, and the system 100 can initiate a brew cycle responsive to selection of this start button 150, as described below.

### 12. Start-Up Cycle

In one variation, when the machine is turned “ON,” the system 100 can immediately execute a start-up cycle to check the water level and water temperature in the boiler 120. For example, if a signal output by the low-level probe 128 indicates that the water level in the boiler 120 is below the target hold volume, the system 100 can trigger the relief valve 129 to open and activate the reservoir pump 112 until output of the low-level probe 128 changes while concurrently activating the heating element 124 to drive water in the boiler 120 up to the target hold temperature (e.g., 94° C., as described below). Similarly, if the temperature sensor 122 in the boiler 120 indicates that the temperature of water in the boiler 120 is less than the target hold temperature but the low-level probe 128 indicates that at least the target hold volume of water is present in the boiler 120, the system 100 can activate the heating element 124 to drive water in the boiler 120 up to the target hold temperature.

### 13. Brew Cycle Initiation

As shown in FIG. 2, while ON and waiting for a next brew cycle, the system 100 can implement closed-loop controls to maintain the target hold volume of water in the boiler 120 at the target hold temperature. When a user then scans a barcode (or other identifier) on a packet containing whole coffee beans (e.g., a single-serving of whole roasted coffee grounds) across the scanner, the scanner can read an identifier from the packet, and the system 100 can reference this identifier against a local or remote recipe database to retrieve a brew recipe for the contents of this packet. In response to retrieval of this brew recipe or otherwise confirming that the packet contains coffee beans, such as described above, the system 100 can sample the waste sensor over the compost bin for a level of waste in the compost bin; if the level of waste detected by the waste sensor exceeds a waste level threshold, the system 100 can output a visual and/or audible cue to empty the compost bin. However, once the system 100 confirms—via the waste sensor—that the level of waste in the compost bin is less than the threshold and that the compost bin is present, the system 100 can trigger the door actuator 144 to open the inlet door 143. The user may then tear the packet open, empty the packet into the grinder 140 via the inlet door 143, and manually close the inlet door 143.

Once user closes the door—and before the user selects the start button 150 to initiate a brew cycle to brew a cup of coffee from these whole coffee beans—the system 100 can immediately execute a temperature adjustment routine. In particular, during this temperature adjustment routine, if the target brew temperature specified by the brew recipe is less than the target hold temperature (or is less than the current temperature of heated water in the boiler 120, as read from the boiler 120 temperature sensor 122), the system 100 can: sample the reservoir 110 temperature sensor 122 for the temperature of water in the reservoir 110; calculate a target volume of cool water in the reservoir 110 to transfer into the boiler 120 to drive the average temperature of water in the boiler 120 to the target brew temperature for the current brew cycle based on a difference between the target hold temperature and the target brew temperature, the current volume of water in the boiler 120 (e.g., the target hold volume), and the current temperature of water in the reservoir 110; calculate a reservoir pump 112 activation time by dividing the target volume of cool water by a known or recently-measured volume flow rate of the reservoir pump 112; and then immediately activate the reservoir pump 112 for this reservoir pump 112 activation time.

Similarly, if the target brew temperature specified by the brew recipe is more than the target hold temperature (or is less than the current temperature of heated water in the boiler 120, as read from the boiler 120 temperature sensor 122), the system 100 can immediately activate the heating element 124 in the boiler 120—after the user closes the inlet door 143 and before the user depresses the start button 150—in order to increase the temperature of water in the boiler 120 and then deactivate the heating element 124 once the boiler 120 temperature sensor 122 outputs a signal that indicates that water in the boiler 120 has reached the target temperature. Alternatively, the system 100 can: calculate a target energy input into the boiler 120 to drive the average temperature of water in the boiler 120 to the target brew temperature for the current brew cycle based on a difference between the target hold temperature and the target brew temperature, the heat capacity of liquid water, and the current volume of water in the boiler 120 (e.g., the target hold volume); calculate a heating element 124 activation time by dividing the target energy input by a known heat flux of the heating element 124; and then immediately activate the heating element 124 for this heating element 124 activation time.

The system 100 can thus dose the boiler 120 with additional energy or with cooler water from the reservoir 110 for a calculated duration of time in order to rapidly drive the average temperature of water in the boiler 120 to the target brew temperature immediately after the user deposits a serving of whole coffee beans into the grinder 140 and closes the inlet door 143—and before the user selects the start button 150 to initiate the brew cycle, thereby shortening a duration of the brew cycle after the user selects the start button 150 and reducing the total duration of the brew cycle perceived by the user, such as by several seconds. The system 100 can therefore drive the average temperature of water in the boiler 120 to (or closer to) the target brew temperature before the user selects the start button 150.

Once the user selects the start button 150, the system 100 can sample the cup sensor to confirm that a cup is present under the brew dispense port 152; if not, the system 100 can serve a visual prompt and/or an audible cue to place a cup under the brew dispense port 152 and to reselect the start button 150. Once the system 100 confirms presence of a cup under the brew dispense port 152 following selection of the start button 150, the system 100 can: activate the grinder 140 to grind this serving of whole coffee beans; and immediately actuate the grinder adjustment actuator 148 to adjust the grind size output by the grinder 140 to the grind size specified by the brew recipe for the current brew cycle. (In one variation of the grinder 140 that is configured for adjustment when not active, the system 100 can alternatively adjust the grinder adjustment actuator 148 to set the grind size of the grinder 140 after the user closes the inlet door 143 and before the user selects the start button 150.) For example, the system 100 can activate the primary grinder actuator 146 for a preset duration of time sufficient to grind a serving of whole coffee beans in its entirety, such as a preset duration of ten seconds of a duration specified in the brew recipe. The grinder 140 can dispense these coffee grounds directly into the brew chamber 130, as described above.

Once a threshold proportion of these whole coffee beans have been ground and dispensed into the brew chamber 130 (e.g., after a threshold proportion—such as 50%—of the grind duration has passed), the system 100 can: trigger the relief valve 129 to close; and actuate the boiler pump 121 for a preset duration of time in order to displace a target volume of water (e.g., 300 mL) from the boiler 120 into the brew chamber 130. Once this target volume of water is displaced into the brew chamber 130 (or once the boiler pump 121 is actuated), the system 100 can set a brew timer for a duration specified by the brew recipe.

While the boiler pump 121 is actively displacing water from the boiler 120 into the brew chamber 130 or once the target volume of water has been displaced from the boiler 120 into the brew chamber 130, the system 100 can also activate the brew chamber 130 pump in the first direction in order to displace air into the brew chamber 130 via the filter 136 on the piston 132—such as for all or a portion of the brew cycle, as specified by the brew recipe—thereby agitating the contents of the brew chamber 130 and increasing flavor extraction from coffee grounds into the water in the brew chamber 1300.

(Simultaneously, the system 100 can: trigger the relief valve 129 to open; activate the reservoir pump 112 to refill the boiler 120 with water from the reservoir 110; deactivate the reservoir pump 112 once the low-level probe 128 indicates that the target hold volume of water is present in the boiler 120; and then implement closed-loop controls to activate the heating element 124 and thus heat the contents of the boiler 120 to the target hold temperature based on temperature values read from the boiler 120 temperature sensor 122. The system 100 can thus refill and begin reheating contents of the boiler 120 in preparation for a next brew cycle while the current brew cycle is still ongoing, thereby reducing a reset time for the system 100 and enabling the system 100 to execute another brew cycle to brew a next cup of coffee soon or immediately after completing the current brew cycle.)

Upon expiration of the brew timer, the system 100 can immediately activate the brew chamber 130 pump in the second direction in order to actively draw liquid (i.e., “coffee”) out of the brew chamber 130—via the filter 136 and the piston 132 port on the piston 132—and to dispense this liquid out of the brew dispense port 152 and into a cup below. In particular, the system 100 can activate the brew chamber 130 pump for a preset dispense time: over which the bulk of liquid in the brew chamber 130 is actively drawn out of the brew chamber 130; and over which air is subsequently drawn through grounds remaining in the brew chamber 130, through the filter 136, and out of the brew dispense port 152 in order to further dry this volume of grounds remaining in the brew chamber 130. For example, the system 100 can activate the brew chamber 130 pump for a preset dispense time of fifteen seconds; the brew chamber 130 pump can draw bulk liquid out of the brew chamber 130 over the first eight seconds of this period and then draw air through these grounds over the remaining seven seconds of this period in order to further dry these coffee grounds. By thus extracting moisture from these used coffee grounds before discarding these used grounds into the compost bin at the end of each brew cycle, as described below, the system 100 can thus reduce moisture that collects in the compost bin, increase volumetric efficiency of the composite bin, increase cleanliness of the brew chamber 130, decrease weight of the compost bin, and reduce opportunity for mold, fungus, and bacteria to grow in the waste chamber over time and improve longer-term cleanliness of the system 100.

While the brew chamber 130 pump is active, the system 100 can also actuate the piston actuator 134 to drive the piston 132 toward the top of the brew chamber 130. For example, the system 100 can actuate the piston actuator 134 to drive the piston 132 up the brew chamber 130 at a rate proportional to a volume flow rate of fluid drawn out of the brew chamber 130 by the brew chamber actuator 139 but lagging the brew chamber actuator 139 by two seconds in order to maintain the liquid level inside the brew chamber 130 below the top of the brew chamber 130 as this liquid is actively pumped out of the brew chamber 130.

Once the piston actuator 134 has raised the piston 132 to a top position in which the filter 136 is approximately flush with the top of the brew chamber 130 and the system 100 has deactivated the brew chamber 130 pump, the system 100 can trigger the scraper 138 actuator to advance forward to the compost bin, thereby driving (relatively dry) coffee grounds from the piston 132 into the compost bin. Finally, the system 100 can trigger the scraper 138 actuator to retract the scraper 138 to the opposite side of the brew chamber 130 and then trigger the piston actuator 134 to retract the piston 132 back to the bottom of the brew chamber 130, thereby resetting the system 100 in preparation for a next brew cycle.

As a person skilled in the art will recognize from the previous detailed description and from the figures and claims, modifications and changes can be made to the embodiments of the invention without departing from the scope of this invention as defined in the following claims.

I claim:

1. A method for brewing a cup of coffee includes:
activating a reservoir pump to dispense cool water from a reservoir into a boiler to fill the boiler with a target hold volume of water;
heating contents of the boiler to a target hold temperature within a range of possible target brew temperatures;
in response to scanning an identifier from a single-serving packet of whole coffee beans:
retrieving a brew recipe for the single-serving packet based on the identifier; and
triggering an inlet door to open;
in response to the brew recipe specifying a target brew temperature less than the target hold temperature, calculating a target volume of cool water to pump from the reservoir into the boiler to drop an average temperature of water in the boiler to the target brew temperature based on a temperature of water in the reservoir, the target hold volume, the target hold temperature, and the target brew temperature;
in response to the inlet door closing:
activating the reservoir pump to dispense the target volume cool water from the reservoir into the boiler; and
activating a grinder actuator to grind a volume of whole coffee beans, previously loaded into a grinder via the inlet door, into grounds dispensed by the grinder into a brew chamber;
in response to the grinder grinding a threshold portion of the volume of whole coffee beans into coffee grounds, activating a boiler pump to displace a volume of heated water, approximately at the target brew temperature, from the boiler into the brew chamber;
actuating a brew chamber pump in a first direction to pump air through a piston in the brew chamber to agitate coffee grounds and the volume of heated water in the brew chamber;
in response to conclusion of a brew duration specified by the brew recipe, actuating the brew chamber pump in a second direction to pump liquid out of the brew chamber through a filter arranged across a face of the piston, through the piston, and though a dispense port arranged over a cup stand and in order to remove moisture from coffee grounds located in the brew chamber; and
triggering a piston actuator to raise the piston to a position flush with a top of the brew chamber; and
triggering a scraper actuator to drive a scraper forward over the top of the brew chamber, over the face of the piston, and toward a waste bin to discard coffee grounds from the brew chamber into the waste bin.
